(19) United States
(12) Patent Application Publication
(10) Pub. No.: US 2026/0075611 A1
(43) Pub. Date: Mar. 12, 2026

(54) METHODS AND APPARATUS FOR RELAXATION OF UPLINK PROCESSING TIMELINE

(71) Applicant: APPLE INC., Cupertino, CA (US)

(72) Inventors: Seyed Ali Akbar Fakoorian, San Diego, CA (US); Dawei Zhang, Saratoga, CA (US); Wenshu Zhang, Sunnyvale, CA (US); Parisa Babaheidarian, Saratoga, CA (US); Wei Zeng, Saratoga, CA (US)

(21) Appl. No.: 19/288,361

(22) Filed: Aug. 1, 2025

Related U.S. Application Data
(60) Provisional application No. 63/693,986, filed on Sep. 12, 2024.

(51) Int. Cl. H04W 72/21; H04L 27/26; H04W 72/115

(52) U.S. Cl. CPC H04W 72/21; H04L 27/26025; H04W 72/115

(57) ABSTRACT

Systems, methods and apparatuses for uplink (UL) processing timeline are discussed herein. In some embodiments a network node may define anchor timing for a user equipment (UE) by determining a starting symbol (Sₓ) for the anchor timing, and determining a processing time for the UE. The anchor timing defines a period reserved for the UE to process uplink grants for a slot. The network node may determine a freeze point that is positioned at least the processing time before Sₓ, and send, to the UE, the uplink grants prior to the freeze point.

### TECHNICAL FIELD

This application relates generally to wireless communication systems, including processing timelines.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems'standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example processing timeline in accordance with some embodiments.

FIG. 2 illustrates another example processing timeline in accordance with some embodiments.

FIG. 3 illustrates yet another example processing timeline in accordance with some embodiments.

FIG. 4 illustrates an example processing timeline, according to embodiments herein.

FIG. 5 illustrates an example processing timeline with two possible freeze points for two anchor timings, according to embodiments herein.

FIG. 6 illustrates an example processing timeline in which the HARQ overlaps the PUSCH, according to embodiments herein.

FIG. 7 illustrates an example processing timeline where T_{proc} and Sₓ are different for different priority orders, according to embodiments herein.

FIG. 8 illustrates an example of physical uplink control channel (PUCCH) resource determination.

FIG. 9A and FIG. 9B illustrate other examples of PUCCH resource determination.

FIG. 10 illustrates an example where the LP HARQ-ACK PUCCH is overridden by the network but the DCI (DL-DCI 2) is missed, according to embodiments herein.

FIG. 11 illustrates a method performed by a network node, according to embodiments herein.

FIG. 12 illustrates an example architecture of a wireless communication system, according to embodiments disclosed herein.

FIG. 13 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

### Uplink Processing in NR

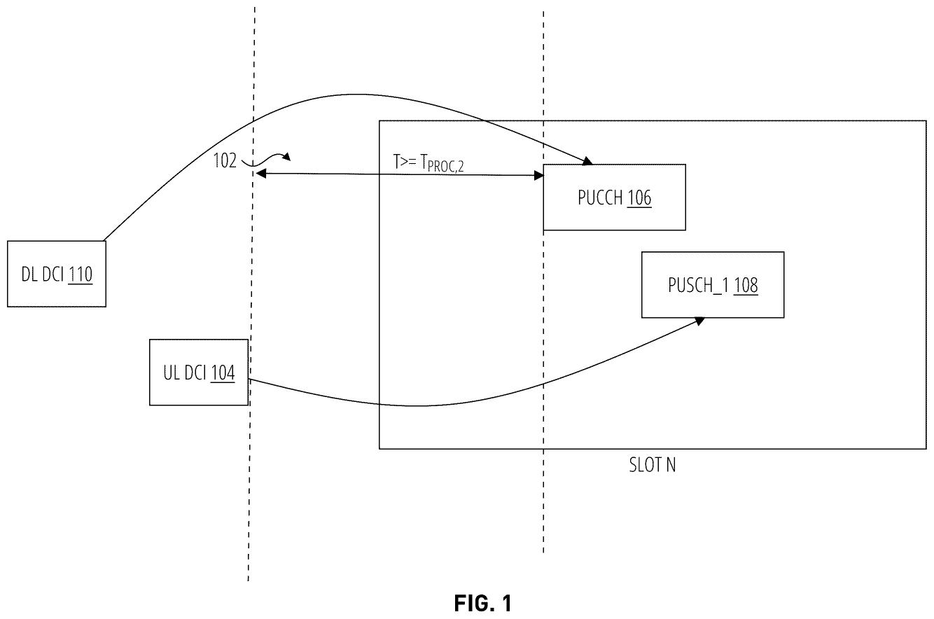

FIG. 1 illustrates an example processing timeline in accordance with some embodiments. In the illustrated embodiment, the UE receives a DL DCI 110 and a UL DCI 104 which correspond to PUCCH 106 and PUSCH_1 108 respectively. In the illustrated embodiment, the time 102 between the UL DCI 104 and the PUCCH 106 is greater than or equal to a processing timeline.

In some wireless communication system, a processing timeline for uplink control information (UCI) multiplexing on the physical uplink control channel (PUCCH) and/or the physical uplink shared channel (PUSCH) may be provided in, for example, 3GPP technical specification (TS) 38.213 clause 9 in section 9.2.5. For example, the processing timeline may be based on the last symbol of the latest downlink control information (DCI) symbol, if any, and/or the first symbol of the earliest overlapping UL grant and physical downlink shared channel (PDSCH) and/or PUSCH processing timelines as provided in, for example, 3GPP TS 38.214 section 5.3 and section 6.4 respectfully.

The procedure to determine the processing timeline may be complicated as it may depend on couple of factors including whether a DCI is involved, the content of the UCI (e.g., scheduling request (SR) cannot be multiplexed on A-channel state information (CSI) without data), mixed numerologies and/or mixed UE processing capabilities, and/or same vs different physical (PHY) priorities.

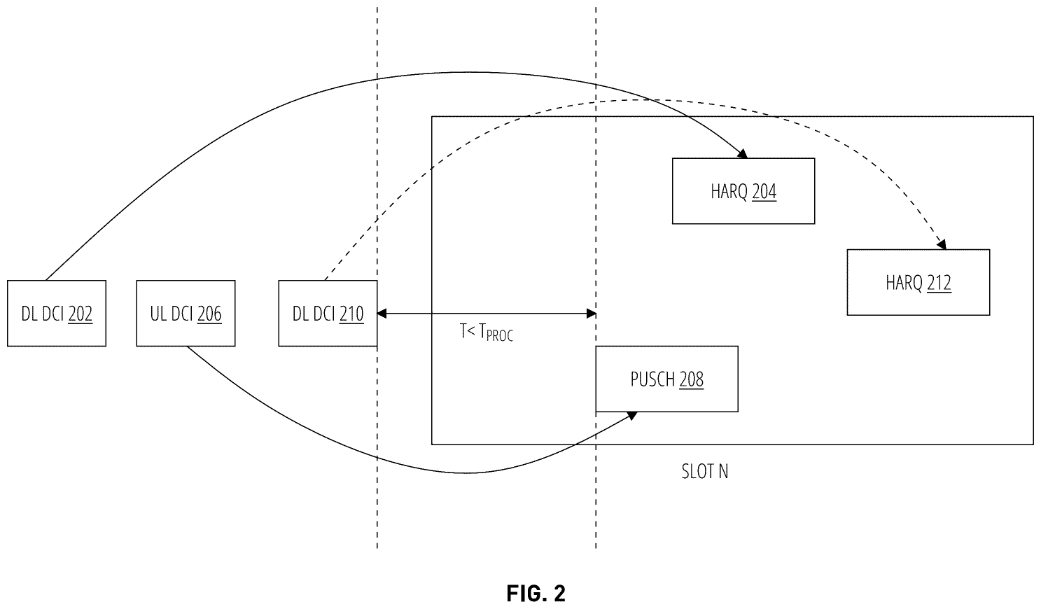

FIG. 2 illustrates another example processing timeline in accordance with some embodiments. In some wireless communication mechanisms, the existing flexibility at the scheduler may possibly need more check points at the UE side.

FIG. 2 illustrates an example (referred to herein as “Example 1”) where existing flexibility at the scheduler needs more check points at the UE side. If a PUSCH is overlapping with a PUCCH which is indeed overridden by a second downlink (DL) DCI, the UE may not have enough time to realize that the first PUCCH with hybrid automatic repeat request-acknowledgement (HARQ-ACK) is overridden.

For instance, as shown, the UE may receive a first DL DCI 202. The first DL DCI 202 may be associated with a first HARQ 204. Later, the UE receives a UL DCI 206 which schedules a PUSCH 208. In the illustrated example, the PUSCH 208 overlaps with the first HARQ 204. The UE may go through with a multiplexing procedure for the first HARQ 204 and the PUSCH 208. However, that may not be what the network expects the UE to do.

For instance, as shown, the network may send a second DL DCI 210 to the UE to override the first DL DCI 202. However, the second DL DCI 210 is received too late, and the UE does not determine that the first PUCCH with the first HARQ 204 that is associated with the first DL DCI 202 is overridden by the second DL DCI 210 in time.

Note that in such examples all timelines may be met by the scheduler. It may be that the time between second DL DCI 210 and first PUCCH is not less than N3, and the final PUCCH (e.g., the PUCCH with the second HARQ 212) is not overlapping with the PUSCH 208, so the network may not be mandated to assure that the second DL DCI 210 is received a certain time (e.g., T_{proc2}) before the start of the PUSCH.

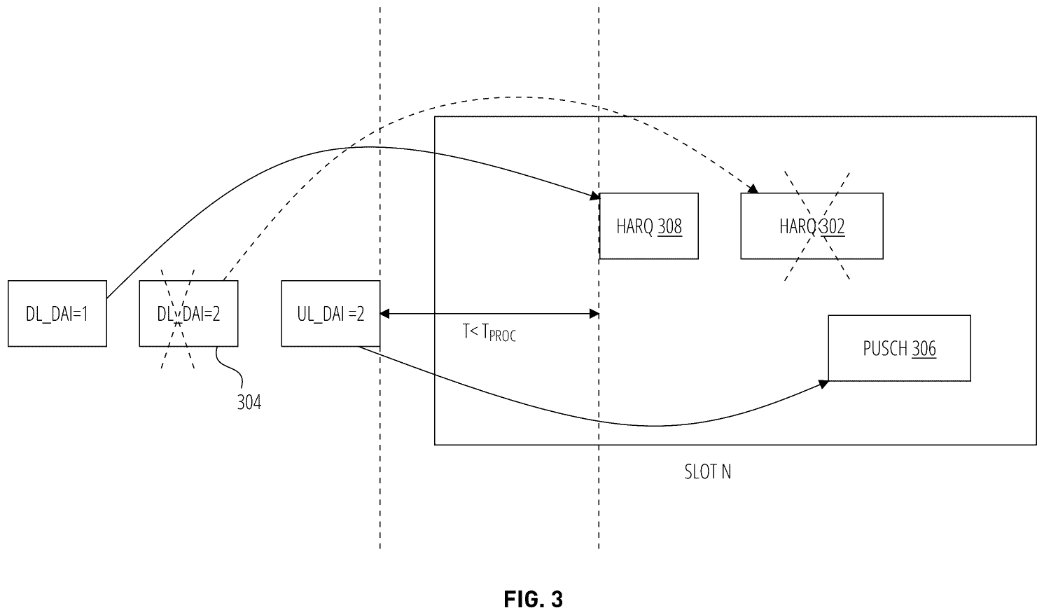

FIG. 3 illustrates yet another example processing timeline in accordance with some embodiments. FIG. 3 illustrates an example (referred to herein as “Example 2”) where existing flexibility at the scheduler needs more check points at the UE side.

In the illustrated example, the latest DL DCI (e.g., DL DCI 304 which corresponds to second HARQ 302) is missed by the UE, the PUSCH 306 may be scheduled late and may start toward the end of the PUCCH slot. As a result, the UE may not have enough time to realize that the first PUCCH with HARQ-ACK (e.g., HARQ 308) is overridden.

Note that such examples the timelines may be met by the scheduler. It may be that the time between the DL DCI with downlink assignment index (DAI)=2 and first PUCCH is not less than N3, and the time between the UL DCI with DAI=2 and 2nd PUCCH is not less than a certain time period (e.g., T_{proc,2}).

Some embodiments herein describe new UCI multiplexing timelines that may be used to prevent the issues shown in FIG. 2 and FIG. 3.

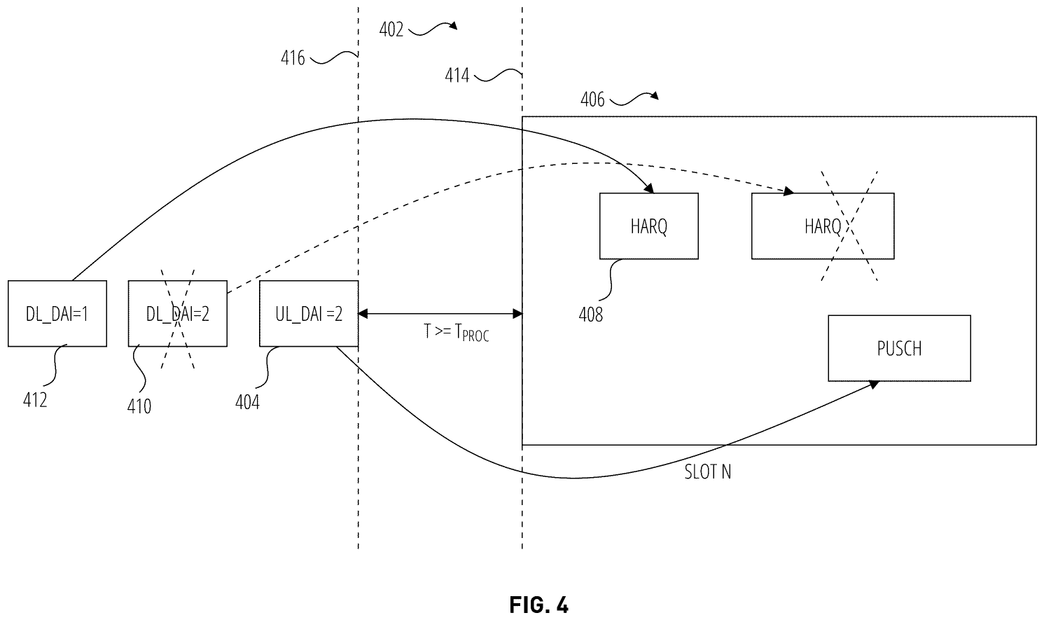

FIG. 4 illustrates an example processing timeline, according to embodiments herein.

In some embodiments, an anchor timing 402 for processing UL grants (e.g., UL DAI 404) within the PUCCH slot may be defined. For example, the anchor timing 402 may start from symbol Sₓ 414, and extend to a freeze point 416. Note that embodiments detailing Sₓ 414 are further discussed herein. The UE does not expect any UL grant within the PUCCH slot to be associated with a DCI which is received after T_{proc} symbols before Sₓ. Additionally, embodiments detailing T_{proc} are further discussed herein.

According to embodiments herein, the ambiguity in Example 2 (shown in FIG. 3) may be resolved when the UL DCI is moved to the left (i.e., Sₓ=0).

For instance, in some embodiments, anything associated with slot N 406 is received before the anchor timing 402. As shown, in some embodiments the anchor timing 402 may be defined from the beginning of PUCCH slot (e.g., slot N 406). The anchor timing 402 may provide sufficient processing time to ensure that the UE can properly process the downlink DCI and the uplink DCI and associated HARQ/PUSCH.

The anchor timing 402 may allow the UE to process the received DCIs to properly determine that it should not transmit HARQ 408 due to the second DL DAI 410 overriding the first DL DAI 412.

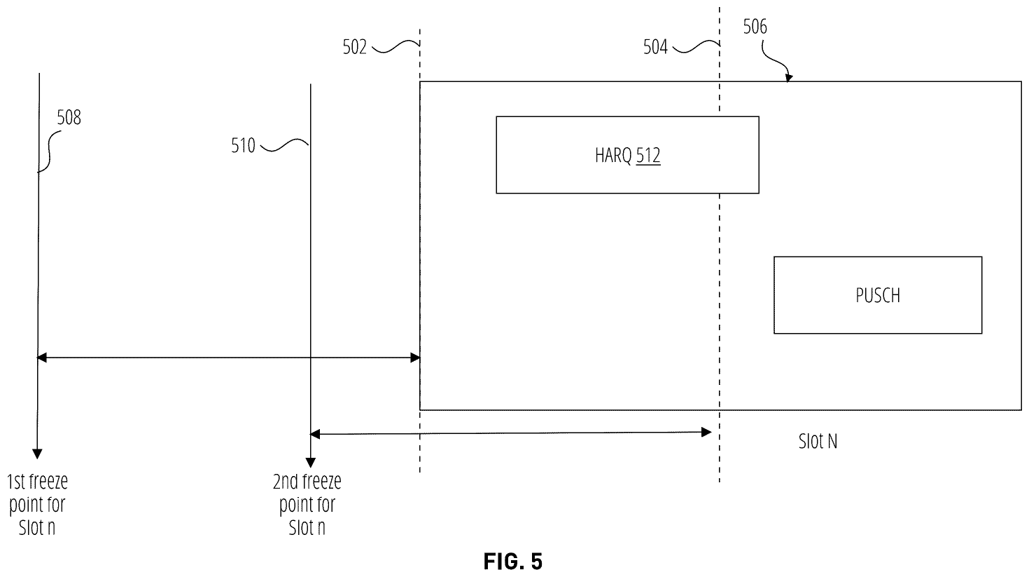

FIG. 5 illustrates an example processing timeline with two possible freeze points for two anchor timings, according to embodiments herein. DCI from the network should be received prior to the freeze points to ensure proper handling. The freeze points may be a point in time before the anchor points at which time UL DCI for a given period should be received.

In some embodiments, the anchor timing Sₓ may be fixed (e.g. Sₓ=0, i.e. the start of PUCCH slot). Alternatively, in some cases, Sₓ can be reported by UE capability. In some embodiments, Sₓ may be at the start of the earliest UL grant in the PUCCH slot.

In some embodiments, more than one Sₓ may be defined per PUCCH slot (e.g., first anchor timing starting symbol 502 and second anchor timing starting symbol 504). For example, in the illustrated embodiment, the first anchor timing starting symbol 502 is Sₓ=0 and the second anchor timing starting symbol 504 is Sₓ=7 (i.e., beginning and middle of PUCCH slot 506). In some instances, any UL grant that starts in the first half of the PUCCH slot 506 may not be associated with a DCI that is received after first freeze point 508, and any UL grant that starts in the second half of the PUCCH slot 506 cannot be associated with a DCI that is received after the second freeze point 510. For example, the HARQ 512 may be associated with a DCI received before first freeze point 508 because it starts prior to the second anchor timing starting symbol 504.

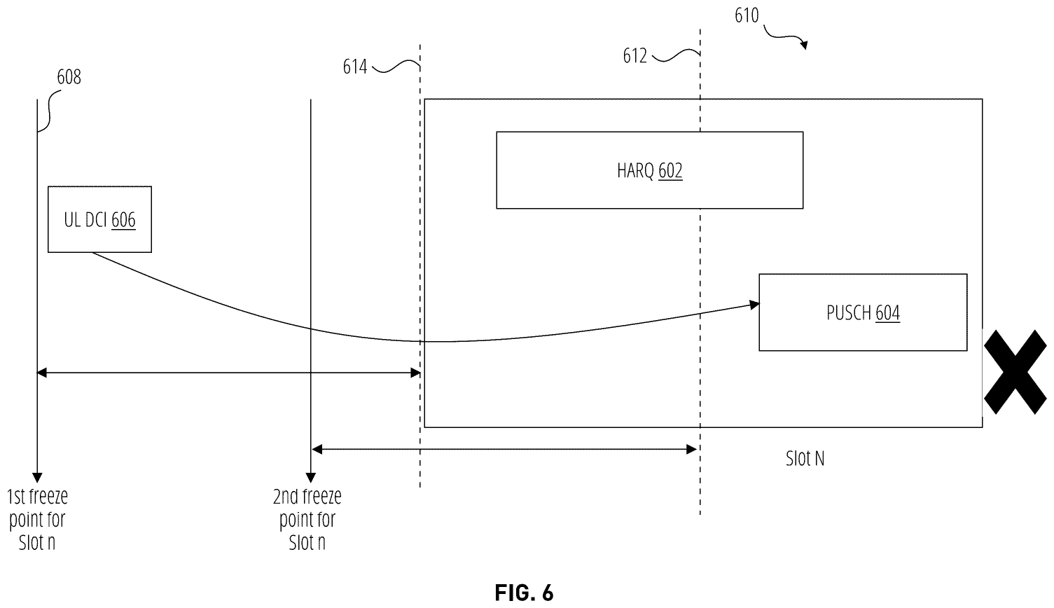

FIG. 6 illustrates an example processing timeline in which the HARQ 602 overlaps the PUSCH 604, according to embodiments herein.

In some embodiments, in cases where more than one Sₓ is defined per PUCCH slot 610, an UL grant that starts in region 1 (e.g., the region of the PUCCH slot 610 after the first Sₓ 614 and before the second Sₓ 612) cannot overlap with another UL grant that starts in region 2 (e.g., the region of the PUCCH slot 610 after the second Sₓ 612), if the uplink grant that starts in region 2 is associated with a DCI that is detected after freezing point corresponding to region 1. It should be understood that region 1 is a region in PUCCH slot before region 2.

In the illustrated embodiment, the PUSCH 604 in the 2nd half of the PUCCH slot 610 is scheduled by a DCI (i.e., UL DCI 606) which is detected after the first freeze point 608 for Slot n. At the time the UE processes the PUCCH (e.g., HARQ 602), it is not aware of any overlapping PUSCH. Accordingly, in some embodiments an UL grant that starts in region 1 cannot overlap with another UL grant that starts in region 2, if the UL grant that starts in region 2 is associated with a DCI that is detected after a freezing point corresponding to region 1.

In some embodiments, the time between the duration of the anchor timing (e.g., the time between the defined anchor timing start symbol and the freeze point) may be greater than or equal to a processing time (e.g., T_{proc}). In some embodiments, T_{proc} may be defined based on UE processing capability as a function of what is supposed to be canceled/overridden in the PUCCH slot. For example, in Example 1 discussed with reference to FIG. 2, multiplexing on the PUSCH is overridden for which T_{proc2} (or N₂) symbols is needed. In Example 2 discussed with reference to FIG. 3, the first PUCCH is overridden for which N₃ symbols is needed. Given that UE is not aware of what will be overridden, the network may assume the worst case scenario and/or the safest timeline which is max(N₂, N₃)=N₂. Note that N₂ and N₃ are subject to UE capabilities (different values for capability 1 and capability 2). In some examples, T_{proc} may be defined based on the minimum Subcarrier Spacing (SCS) between the involved channels (e.g., physical downlink control channel (PDCCH), PUCCH, PUSCH).

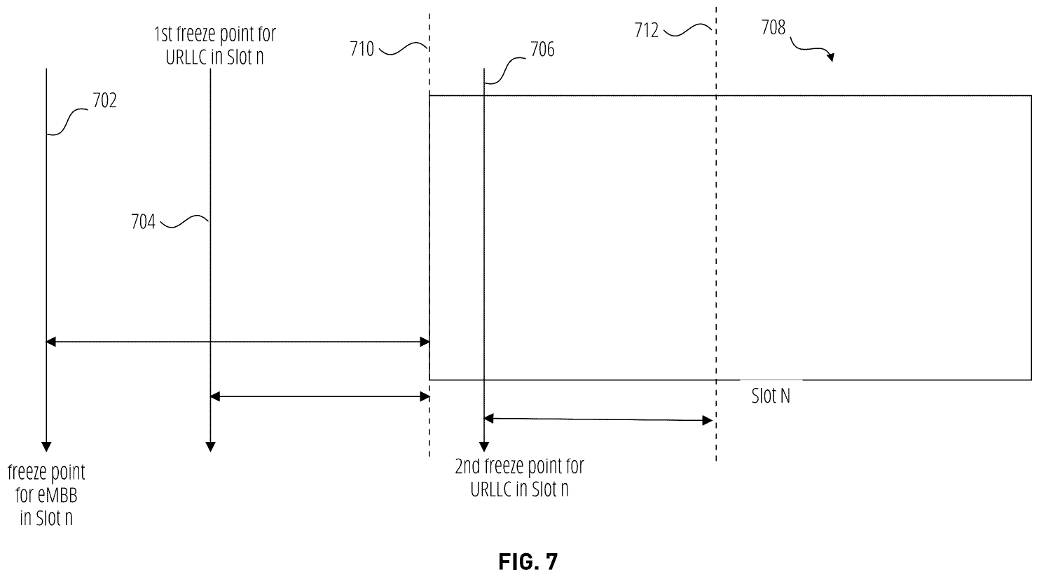

FIG. 7 illustrates an example processing timeline where T_{proc} and Sₓ are different for different priority orders, according to embodiments herein.

In some embodiments, T_{proc} and/or Sₓ may be different for different priority orders. For example, for low priority UL grants, only one Sₓ within the PUCCH slot may be defined while for high priority grants, the UE may expect two Sₓ points within the PUCCH slot. In some embodiments, two different T_{proc} may be defined one for low priority grant and another one for high priority grant.

For instance, in FIG. 7, different anchor timing is defined for signals based on priority. Enhanced Mobile Broadband (eMBB) may not be as sensitive to latency as Ultra-Reliable Low-Latency Communications (URLLC). Accordingly, eMBB may have a freeze point that is further away from slot n 708. In the illustrated embodiment, a freeze point for eMBB 702 and a first freeze point for URLLC 704 in combination with a first Sₓ point 710 define two anchor timings. The freeze point for eMBB 702 defines a symbol before which the network should send any eMBB signaling. The first freeze point for URLLC 704 defines a symbol before which the network should send any URLLC signaling corresponding to grants starting in the beginning region of slot n 708.

Additionally, a second freeze point for URLLC 706 in slot n 708 is defined for grants that start in the second region of the slot n 708 after Sₓ point 712.

Note that while the example herein discusses with reference to a slot, the ideas may be extended to multiple slots.

### Simplification on PUCCH Resource Determination

In some wireless communication systems, when multiple PUCCH resources overlap, the resultant PUCCH resource determination may be a complicated procedure which depends on factors including whether or not a DCI is involved, whether or not a PUCCH with repetition is involved, and/or the content of the UCI. Assuming none of overlapping PUCCH resources come with repetitions, and at least one of PUCCH resources in the set of overlapping resources is associated with a DCI (i.e., it contains HARQ-ACK corresponding to a DG-PDSCH), the PRI in the DCI indicates the PUCCH resource to carry the HARQ-ACK. This resource is selected from a PUCCH resource set, PUCCH-ResourceSet, corresponding to HARQ-ACK payload size as provided in 3GPP TS 38.213 section 9.2.1 (provided below). In some examples, if the PUCCH resource is overlapping with other PUCCH resources, the UE may go through a pseudo code in 3GPP TS 38.213 section 9.2.5 to determine the resultant PUCCH resource, however now with the updated UCI payload size including HARQ-ACK/SR, and CSI.

3GPP TS 38.213 Section 9.2.1:

A UE can be configured up to four sets of PUCCH resources in a PUCCH-Config. A PUCCH resource set is provided by PUCCH-ResourceSet and is associated with a PUCCH resource set index provided by pucch-ResourceSetId, with a set of PUCCH resource indexes provided by resourceList that provides a set of pucch-ResourceId used in the PUCCH resource set, and with a maximum number of UCI information bits the UE can transmit using a PUCCH resource in the PUCCH resource set provided by maxPayloadSize. For the first PUCCH resource set, the maximum number of UCI information bits is 2. A maximum number of PUCCH resource indexes for a set of PUCCH resources is provided by maxNrofPUCCH-ResourcesPerSet. The maximum number of PUCCH resources in the first PUCCH resource set is 32 and the maximum number of PUCCH resources in the other PUCCH resource sets is 8.

If the UE transmits O_{UCI} UCI information bits, that include HARQ-ACK information bits, the UE determines a PUCCH resource set to be:
a first set of PUCCH resources with pucch-ResourceSetId=0 if O_{UCI}≤2 including 1 or 2 HARQ-ACK information bits and a positive or negative SR on one SR transmission occasion if transmission of HARQ-ACK information and SR occurs simultaneously, or
a second set of PUCCH resources with pucch-ResourceSetId=1, if provided by higher layers, if 2<O_{UCI}≤N₂ where N₂ is equal to maxPayloadSize if maxPayloadSize is provided for the PUCCH resource set with pucch-ResourceSetId=1; otherwise N₂ is equal to 1706, or
a third set of PUCCH resources with pucch-ResourceSetId=2, if provided by higher layers, if N₂<O_{UCI}≤N₃ where N₃ is equal to maxPayloadSize if maxPayloadSize is provided for the PUCCH resource set with pucch-ResourceSetId=2; otherwise N₃ is equal to 1706, or
a fourth set of PUCCH resources with pucch-ResourceSetId=3, if provided by higher layers, if N₃<O_{UCI}≤1706.

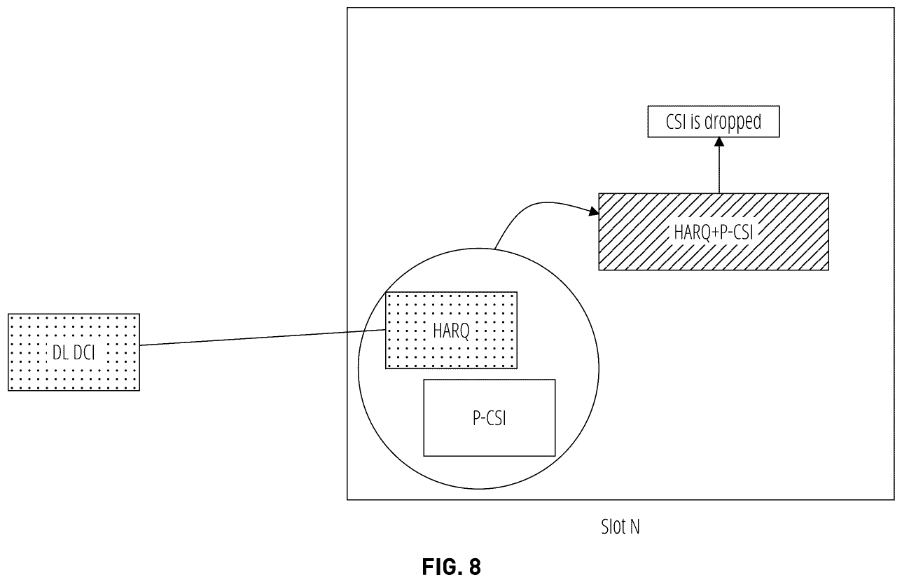

FIG. 8 illustrates an example of PUCCH resource determination.

In some wireless communication mechanisms, through PUCCH resource determination, the resultant PUCCH resource may move within the PUCCH slot. This may occur due to overlapping PUCCH resources and when an increased UCI payload becomes more than maxPayloadSize of the current PUCCH-ResourceSet, and the UE has to apply PRI to another PUCCH-ResourceSet. In some cases, the UE behavior is not known if this is due to a CSI dropping procedure as the payload size reduces to another PUCCH-ResourceSet.

An example is illustrated in FIG. 8 where it is not clear whether UE has to switch back to the first PUCCH (illustrated as being shaded with “dots”) or stay on the second PUCCH (illustrated as being “hatching” shaded with diagonal lines). Note that some PUCCH formats may not be used for some HARQ-ACK payload sizes (e.g. FM2 cannot carry 1 or 2 bits).

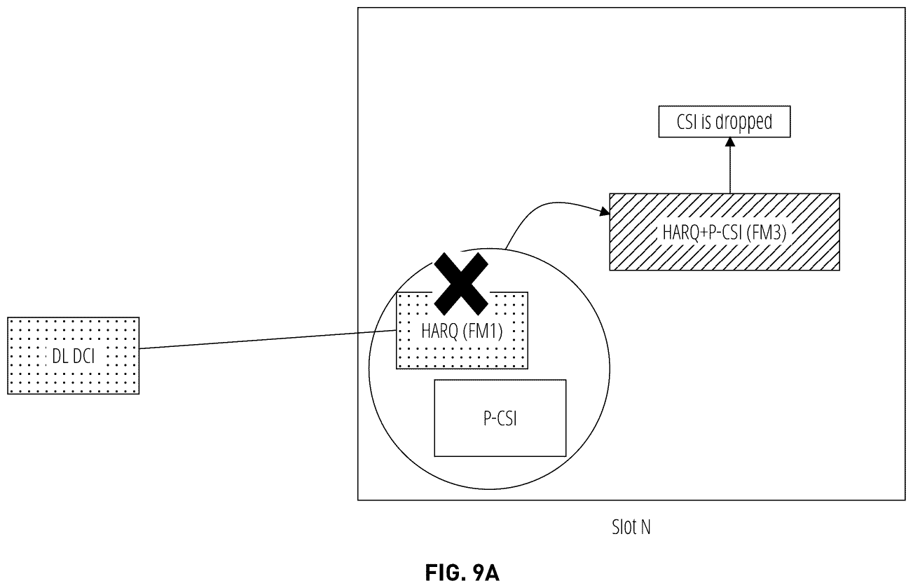

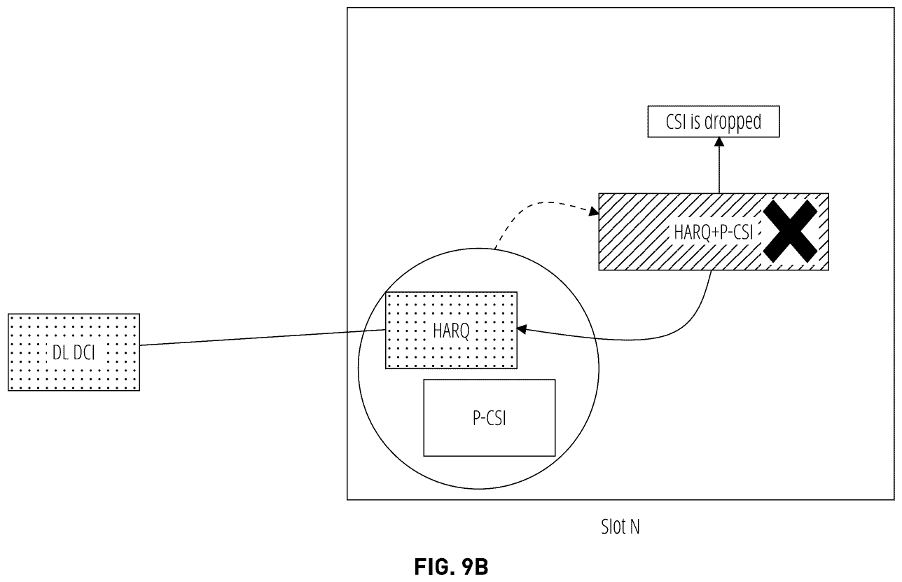

FIG. 9A and FIG. 9B illustrate other examples of PUCCH resource determination.

In some cases, it may be that the UE may stay in a resource (illustrated as being “hatching” shaded with diagonal lines) with FM3 that may not work when there is only a 2 bit HARQ-ACK.

In some other cases, it may be that the UE may go back to the resource (illustrated as being shaded with “dots”) with FM1 that may not work if the UE has already passed OTA.

### PUCCH Resource Determination

In some embodiment, for PUCCH resource sets except the first set of PUCCH resources with pucch-ResourceSetId=0, target PUCCH-ResourceSet is determined by O_{UCI} before the CSI dropping procedure. For example, 2<O_{ACK}≤N₂ so the initial PUCCH is determined from pucch-ResourceSetId=1. The indicated PUCCH for HARQ-ACK overlaps with a P-CSI PUCCH and the result O_{UCI} before CSI dropping procedure is N₂<O_{UCI}≤N₃. As a result, the target PUCCH may be determined from pucch-ResourceSetId=2. If the number of REs in the indicated PUCCH resource is not enough so the CSI may be dropped such that the effective O_{UCI}≤N₃, the PUCCH resource does not change (i.e., it is still determined based on PRI from pucch-ResourceSetId=2).

In some embodiments, for the first set of PUCCH resources with pucch-ResourceSetId=0, the PUCCH resource (with FM0 or 1) is not expected to overlap with a PUCCH with CSI. Alternatively, in some cases, the UE may drop the CSI if PUCCH FM0/1 overlaps with a PUCCH with CSI. This may occur so that the UE does not switch to another PUCCH-ResourceSet. In some other cases, the UE does not expect CSI dropping results no CSI.

In some embodiments, only two formats of PUCCH resources may be defined, where each PUCCH format is capable of carrying 1, 2 or more UCI information bits. In a first format, Format A, there may be up to N symbols where N is for example 2 OS. In a second format, Format B, it may be at least M symbols where M is for example 4 OS.

In some embodiments, the PUCCH resource configuration may include a PUCCH format, starting symbol, duration, starting physical resource block (PRB), nominal number of PRBs, and maxCodeRate. For FMA or FMB, if the PUCCH resource carries only few bits of information (e.g., up to 3 bits), the number of PRBs may be limited to one.

In some embodiments, while for FMA (or FMB) the indicated resource in time does not depend on the UCI payload size, the maximum number of PRBs and maxCodeRate may depend on the payload size. If the PUCCH resource carries more than a few bits of information (e.g., more than 3 bits), a maxCodeRate is configured and applicable. Different payload thresholds may be configured where each threshold is associated with a given maximum number of PRBs and maxCodeRate.

In some embodiments, while for FMA (or FMB) the indicated resource in time does not depend on the UCI payload size, the PUCCH construction may depend on the payload size. For few bits of information a sequence may be mapped to the indicated resource, while for more number of information bits coding can be applied.

For example, the PRI in DCI may indicate an FMA PUCCH from symbol 2 to symbol 3 with a maximum of 5 PRBs.

In some cases (i.e., “Case 1”), the indicated PUCCH carries 2 bits of HARQ-ACK and is not overlapping with a P-CSI PUCCH. In such cases, the FMA in new procedure can be FM0, or any new sequence based design. As a result, only one PRB is used to carry information bits.

In some other cases (i.e., “Case 2”), the indicated PUCCH carries 2 bits of HARQ-ACK but it is overlapping with a P-CSI PUCCH. In such cases, the FMA in a new procedure can be FM2, or any new coding based design. Note that up to maximum 5 configured PRBs can be used depending on the configured code rate and the payload size. CSI dropping is applied if needed Additionally, note that even if all CSI is dropped, there may be no moving on the PUCCH resource as the PUCCH resource in time is determined regardless of the payload.

### Resource Determination of Different Priorities

In some wireless communication systems, resource determination of different PHY priorities may be provided in 3GPP TS 38.213 section 9. For example, when a UE determines overlapping for PUCCH and/or PUSCH transmissions of different priority indexes, other than PUCCH transmissions with SL HARQ-ACK reports, before considering limitations for transmissions including with repetitions, if any, as described in clauses 11.1, 11.1.1, 11.2A, 15 and 17.2, if the UE is not provided uci-MuxWithDiffPrio, the UE first resolves overlapping for PUCCH and/or PUSCH transmissions of smaller priority index as described in clauses 9.2.5 and 9.2.6. Then, if a transmission of a first PUCCH of larger priority index scheduled by a DCI format in a PDCCH reception would overlap in time with a repetition of a transmission of a second PUSCH or a second PUCCH of smaller priority index, the UE cancels the repetition of a transmission of the second PUSCH or the second PUCCH before the first symbol that would overlap with the first PUCCH transmission. If a transmission of a first PUSCH of larger priority index scheduled by a DCI format in a PDCCH reception would overlap in time with a repetition of the transmission of a second PUCCH of smaller priority index, the UE cancels the repetition of the transmission of the second PUCCH before the first symbol that would overlap with the first PUSCH transmission, where the overlapping is applicable before or after resolving overlapping among channels of larger priority index, if any, as described in clauses 9.2.5 and 9.2.6.

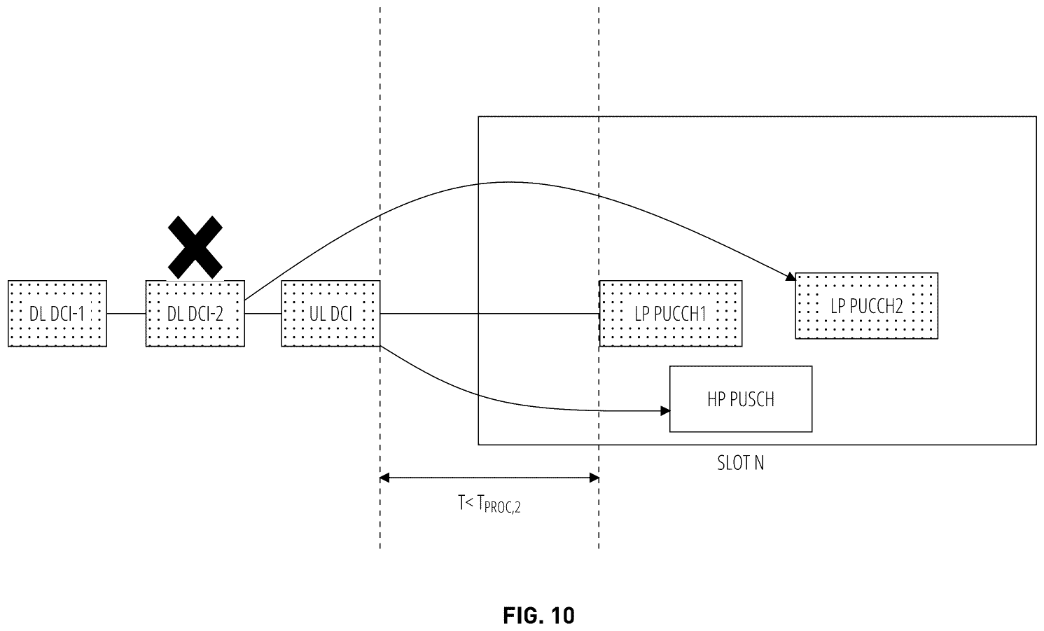

FIG. 10 illustrates an example where the LP HARQ-ACK PUCCH is overridden by the network but the DCI (DL-DCI 2) is missed, according to embodiments herein.

In some wireless communication mechanisms, a low priority grant may not be as reliable as a high priority grant, so the UE may miss the DCI corresponding to an LP grant. In some examples, the LP HARQ-ACK PUCCH is overridden by the network but the DCI (DL-DCI 2) is missed. As a result, the UE does not have enough time to cancel LP PUCCH 1.

In some embodiments, the network may meet a cancelation timeline for all LP grants associated with a DCI that overlap with a HP grant before and after resolving the overlapping for PUCCH and/or PUSCH transmissions of smaller priority index. This is to assure that missing a LP DCI will not impact HP grant.

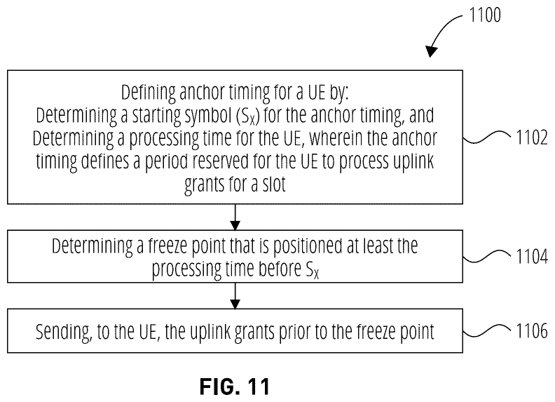

FIG. 11 illustrates a method 1100 performed by a network node, according to embodiments herein. The illustrated method 1100 includes defining 1102 anchor timing for a UE by: determining a starting symbol (Sₓ) for the anchor timing, and determining a processing time for the UE, wherein the anchor timing defines a period reserved for the UE to process uplink grants for a slot. The method 1100 further includes determining 1104 a freeze point that is positioned at least the processing time before Sₓ. The method 1100 further includes sending 1106, to the UE, the uplink grants prior to the freeze point.

In some embodiments of the method 1100, the Sₓ is fixed relative to the slot.

In some embodiments of the method 1100, the Sₓ is reported by UE capability.

In some embodiments, the method 1100 further comprises determining a second Sₓ and a second freeze point, wherein any of the uplink grants that start in a first region of the slot cannot be associated with a DCI that is received after the freeze point, and any of the uplink grants that starts in a second region of the slot cannot be associated with a DCI that is received after the second freeze point. In some such embodiments, a first uplink grant that starts in the first region cannot overlap with a second uplink grant that starts in the second region.

In some embodiments of the method 1100, the processing time is based on a minimum SCS between involved channels.

In some embodiments of the method 1100, the processing time is different for signals with different priorities.

In some embodiments, the method 1100 further comprises receiving, from the UE, a UE capability report, wherein the anchor timing is based on the UE capability report and resources to be processed by the UE within a PUCCH slot.

In some embodiments, the method 1100 further comprises indicating PUCCH formats, and wherein a starting symbol and duration of the PUCCH formats do not change.

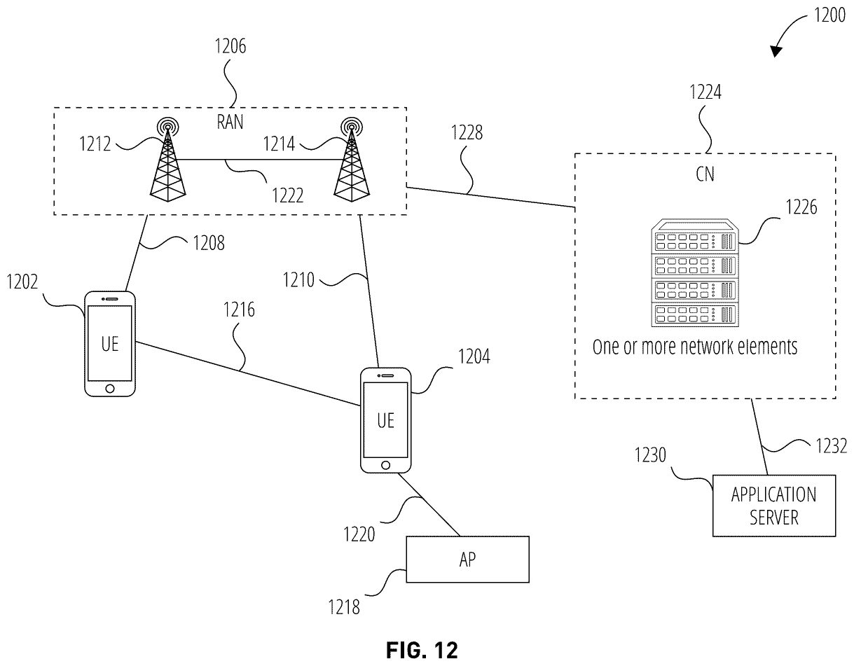

FIG. 12 illustrates an example architecture of a wireless communication system 1200, according to embodiments disclosed herein. The following description is provided for an example wireless communication system 1200 that operates in conjunction with the LTE system standards and/or 5G or NR system standards as provided by 3GPP technical specifications.

As shown by FIG. 12, the wireless communication system 1200 includes UE 1202 and UE 1204 (although any number of UEs may be used). In this example, the UE 1202 and the UE 1204 are illustrated as smartphones (e.g., handheld touchscreen mobile computing devices connectable to one or more cellular networks), but may also comprise any mobile or non-mobile computing device configured for wireless communication.

The UE 1202 and UE 1204 may be configured to communicatively couple with a RAN 1206. In embodiments, the RAN 1206 may be NG-RAN, E-UTRAN, etc. The UE 1202 and UE 1204 utilize connections (or channels) (shown as connection 1208 and connection 1210, respectively) with the RAN 1206, each of which comprises a physical communications interface. The RAN 1206 can include one or more base stations (such as base station 1212 and base station 1214) that enable the connection 1208 and connection 1210.

In this example, the connection 1208 and connection 1210 are air interfaces to enable such communicative coupling, and may be consistent with RAT(s) used by the RAN 1206, such as, for example, an LTE and/or NR.

In some embodiments, the UE 1202 and UE 1204 may also directly exchange communication data via a sidelink interface 1216. The UE 1204 is shown to be configured to access an access point (shown as AP 1218) via connection 1220. By way of example, the connection 1220 can comprise a local wireless connection, such as a connection consistent with any IEEE 802.11 protocol, wherein the AP 1218 may comprise a Wi-Fi® router. In this example, the AP 1218 may be connected to another network (for example, the Internet) without going through a CN 1224.

In embodiments, the UE 1202 and UE 1204 can be configured to communicate using orthogonal frequency division multiplexing (OFDM) communication signals with each other or with the base station 1212 and/or the base station 1214 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1212 or base station 1214 may be implemented as one or more software entities running on server computers as part of a virtual network. In addition, or in other embodiments, the base station 1212 or base station 1214 may be configured to communicate with one another via interface 1222. In embodiments where the wireless communication system 1200 is an LTE system (e.g., when the CN 1224 is an EPC), the interface 1222 may be an X2 interface. The X2 interface may be defined between two or more base stations (e.g., two or more eNBs and the like) that connect to an EPC, and/or between two eNBs connecting to the EPC. In embodiments where the wireless communication system 1200 is an NR system (e.g., when CN 1224 is a 5GC), the interface 1222 may be an Xn interface. The Xn interface is defined between two or more base stations (e.g., two or more gNBs and the like) that connect to 5GC, between a base station 1212 (e.g., a gNB) connecting to 5GC and an eNB, and/or between two eNBs connecting to 5GC (e.g., CN 1224).

The RAN 1206 is shown to be communicatively coupled to the CN 1224. The CN 1224 may comprise one or more network elements 1226, which are configured to offer various data and telecommunications services to customers/subscribers (e.g., users of UE 1202 and UE 1204) who are connected to the CN 1224 via the RAN 1206. The components of the CN 1224 may be implemented in one physical device or separate physical devices including components to read and execute instructions from a machine-readable or computer-readable medium (e.g., a non-transitory machine-readable storage medium).

In embodiments, the CN 1224 may be an EPC, and the RAN 1206 may be connected with the CN 1224 via an S1 interface 1228. In embodiments, the S1 interface 1228 may be split into two parts, an S1 user plane (S1-U) interface, which carries traffic data between the base station 1212 or base station 1214 and a serving gateway (S-GW), and the S1-MME interface, which is a signaling interface between the base station 1212 or base station 1214 and mobility management entities (MMEs).

In embodiments, the CN 1224 may be a 5GC, and the RAN 1206 may be connected with the CN 1224 via an NG interface 1228. In embodiments, the NG interface 1228 may be split into two parts, an NG user plane (NG-U) interface, which carries traffic data between the base station 1212 or base station 1214 and a user plane function (UPF), and the S1 control plane (NG-C) interface, which is a signaling interface between the base station 1212 or base station 1214 and access and mobility management functions (AMFs).

Generally, an application server 1230 may be an element offering applications that use internet protocol (IP) bearer resources with the CN 1224 (e.g., packet switched data services). The application server 1230 can also be configured to support one or more communication services (e.g., VoIP sessions, group communication sessions, etc.) for the UE 1202 and UE 1204 via the CN 1224. The application server 1230 may communicate with the CN 1224 through an IP communications interface 1232.

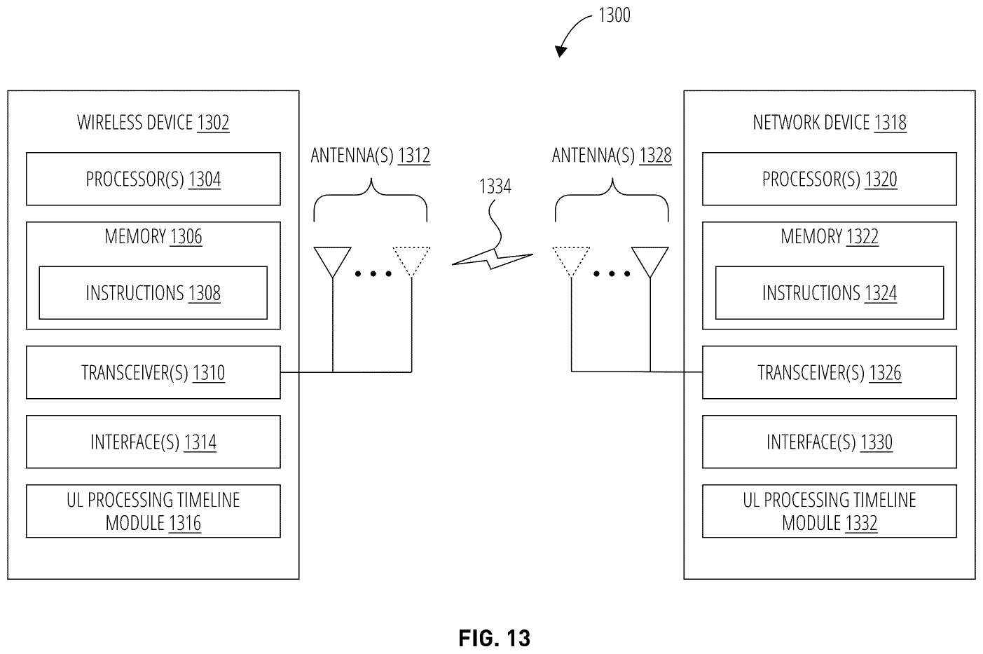

FIG. 13 illustrates a system 1300 for performing signaling 1334 between a wireless device 1302 and a network device 1318, according to embodiments disclosed herein. The system 1300 may be a portion of a wireless communications system as herein described. The wireless device 1302 may be, for example, a UE of a wireless communication system. The network device 1318 may be, for example, a base station (e.g., an eNB or a gNB) of a wireless communication system.

The wireless device 1302 may include one or more processor(s) 1304. The processor(s) 1304 may execute instructions such that various operations of the wireless device 1302 are performed, as described herein. The processor(s) 1304 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1302 may include a memory 1306. The memory 1306 may be a non-transitory computer-readable storage medium that stores instructions 1308 (which may include, for example, the instructions being executed by the processor(s) 1304). The instructions 1308 may also be referred to as program code or a computer program. The memory 1306 may also store data used by, and results computed by, the processor(s) 1304.

The wireless device 1302 may include one or more transceiver(s) 1310 that may include radio frequency (RF) transmitter circuitry and/or receiver circuitry that use the antenna(s) 1312 of the wireless device 1302 to facilitate signaling (e.g., the signaling 1334) to and/or from the wireless device 1302 with other devices (e.g., the network device 1318) according to corresponding RATs.

The wireless device 1302 may include one or more antenna(s) 1312 (e.g., one, two, four, or more). For embodiments with multiple antenna(s) 1312, the wireless device 1302 may leverage the spatial diversity of such multiple antenna(s) 1312 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1302 may be accomplished according to precoding (or digital beamforming) that is applied at the wireless device 1302 that multiplexes the data streams across the antenna(s) 1312 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1302 may implement analog beamforming techniques, whereby phases of the signals sent by the antenna(s) 1312 are relatively adjusted such that the (joint) transmission of the antenna(s) 1312 can be directed (this is sometimes referred to as beam steering).

The wireless device 1302 may include one or more interface(s) 1314. The interface(s) 1314 may be used to provide input to or output from the wireless device 1302. For example, a wireless device 1302 that is a UE may include interface(s) 1314 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1310/antenna(s) 1312 already described) that allow for communication between the UE and other devices and may operate according to known protocols (e.g., Wi-Fi®, Bluetooth®, and the like).

The wireless device 1302 may include a UL processing timeline module 1316.

The UL processing timeline module 1316 may be implemented via hardware, software, or combinations thereof. For example, the UL processing timeline module 1316 may be implemented as a processor, circuit, and/or instructions 1308 stored in the memory 1306 and executed by the processor(s) 1304. In some examples, the UL processing timeline module 1316 may be integrated within the processor(s) 1304 and/or the transceiver(s) 1310. For example, the UL processing timeline module 1316 may be implemented by a combination of software components (e.g., executed by a DSP or a general processor) and hardware components (e.g., logic gates and circuitry) within the processor(s) 1304 or the transceiver(s) 1310.

The UL processing timeline module 1316 may be used for various aspects of the present disclosure. For example, the UL processing timeline module 1316 may be configured to perform any of the UE-based methods discussed herein.

The network device 1318 may include one or more processor(s) 1320. The processor(s) 1320 may execute instructions such that various operations of the network device 1318 are performed, as described herein. The processor(s) 1320 may include one or more baseband processors implemented using, for example, a CPU, a DSP, an ASIC, a controller, an FPGA device, another hardware device, a firmware device, or any combination thereof configured to perform the operations described herein.

The network device 1318 may include a memory 1322. The memory 1322 may be a non-transitory computer-readable storage medium that stores instructions 1324 (which may include, for example, the instructions being executed by the processor(s) 1320). The instructions 1324 may also be referred to as program code or a computer program. The memory 1322 may also store data used by, and results computed by, the processor(s) 1320.

The network device 1318 may include one or more transceiver(s) 1326 that may include RF transmitter circuitry and/or receiver circuitry that use the antenna(s) 1328 of the network device 1318 to facilitate signaling (e.g., the signaling 1334) to and/or from the network device 1318 with other devices (e.g., the wireless device 1302) according to corresponding RATs.

The network device 1318 may include one or more antenna(s) 1328 (e.g., one, two, four, or more). In embodiments having multiple antenna(s) 1328, the network device 1318 may perform MIMO, digital beamforming, analog beamforming, beam steering, etc., as has been described.

The network device 1318 may include one or more interface(s) 1330. The interface(s) 1330 may be used to provide input to or output from the network device 1318. For example, a network device 1318 that is a base station may include interface(s) 1330 made up of transmitters, receivers, and other circuitry (e.g., other than the transceiver(s) 1326/antenna(s) 1328 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1318 may include a UL processing timeline module 1332. The UL processing timeline module 1332 may be implemented via hardware, software, or combinations thereof. For example, the UL processing timeline module 1332 may be implemented as a processor, circuit, and/or instructions 1324 stored in the memory 1322 and executed by the processor(s) 1320. In some examples, the UL processing timeline module 1332 may be integrated within the processor(s) 1320 and/or the transceiver(s) 1326. For example, the UL processing timeline module 1332 may be implemented by a combination of software components (e.g., executed by a DSP or a general processor) and hardware components (e.g., logic gates and circuitry) within the processor(s) 1320 or the transceiver(s) 1326.

The UL processing timeline module 1332 may be used for various aspects of the present disclosure, for example aspects of FIG. 1 through FIG. 11. The UL processing timeline module 1332 is configured to cause the network device 1318 to define anchor timing for a UE by: determining a starting symbol (Sₓ) for the anchor timing, and determining a processing time for the UE, wherein the anchor timing defines a period reserved for the UE to process uplink grants for a slot. The UL processing timeline module 1332 is configured to further cause the network device 1318 to determine a freeze point that is positioned at least the processing time before Sₓ. The UL processing timeline module 1332 is configured to further cause the network device 1318 to send, to the UE, the uplink grants prior to the freeze point.

Embodiments contemplated herein include an apparatus comprising means to perform one or more elements of any of the UE-based methods discussed herein. This apparatus may be, for example, an apparatus of a UE (such as a wireless device 1302 that is a UE, as described herein).

Embodiments contemplated herein include one or more non-transitory computer-readable media comprising instructions to cause an electronic device, upon execution of the instructions by one or more processors of the electronic device, to perform one or more elements of any of the UE-based methods discussed herein. This non-transitory computer-readable media may be, for example, a memory of a UE (such as a memory 1306 of a wireless device 1302 that is a UE, as described herein).

Embodiments contemplated herein include an apparatus comprising logic, modules, or circuitry to perform one or more elements of any of the UE-based methods discussed herein. This apparatus may be, for example, an apparatus of a UE (such as a wireless device 1302 that is a UE, as described herein).

Embodiments contemplated herein include an apparatus comprising: one or more processors and one or more computer-readable media comprising instructions that, when executed by the one or more processors, cause the one or more processors to perform one or more elements of any of the UE-based methods discussed herein. This apparatus may be, for example, an apparatus of a UE (such as a wireless device 1302 that is a UE, as described herein).

Embodiments contemplated herein include a signal as described in or related to one or more elements of any of the UE-based methods discussed herein.

Embodiments contemplated herein include a computer program or computer program product comprising instructions, wherein execution of the program by a processor is to cause the processor to carry out one or more elements of any of the UE-based methods discussed herein. The processor may be a processor of a UE (such as a processor(s) 1304 of a wireless device 1302 that is a UE, as described herein). These instructions may be, for example, located in the processor and/or on a memory of the UE (such as a memory 1306 of a wireless device 1302 that is a UE, as described herein).

Embodiments contemplated herein include an apparatus comprising means to perform one or more elements of the method 1100. This apparatus may be, for example, an apparatus of a base station (such as a network device 1318 that is a base station, as described herein).

Embodiments contemplated herein include one or more non-transitory computer-readable media comprising instructions to cause an electronic device, upon execution of the instructions by one or more processors of the electronic device, to perform one or more elements of the method 1100. This non-transitory computer-readable media may be, for example, a memory of a base station (such as a memory 1322 of a network device 1318 that is a base station, as described herein).

Embodiments contemplated herein include an apparatus comprising logic, modules, or circuitry to perform one or more elements of the method 1100. This apparatus may be, for example, an apparatus of a base station (such as a network device 1318 that is a base station, as described herein).

Embodiments contemplated herein include an apparatus comprising: one or more processors and one or more computer-readable media comprising instructions that, when executed by the one or more processors, cause the one or more processors to perform one or more elements of the method 1100. This apparatus may be, for example, an apparatus of a base station (such as a network device 1318 that is a base station, as described herein).

Embodiments contemplated herein include a signal as described in or related to one or more elements of the method 1100.

Embodiments contemplated herein include a computer program or computer program product comprising instructions, wherein execution of the program by a processing element is to cause the processing element to carry out one or more elements of any of the method 1100. The processor may be a processor of a base station (such as a processor(s) 1320 of a network device 1318 that is a base station, as described herein).

These instructions may be, for example, located in the processor and/or on a memory of the base station (such as a memory 1322 of a network device 1318 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method performed by a network node, the method comprising:
defining anchor timing for a user equipment (UE) by:
determining a starting symbol (Sₓ) for the anchor timing, and
determining a processing time for the UE, wherein the anchor timing defines a period reserved for the UE to process uplink grants for a slot;
determining a freeze point that is positioned at least the processing time before Sₓ; and
sending, to the UE, the uplink grants prior to the freeze point.

2. The method of claim 1, wherein the Sₓ is fixed relative to the slot.

3. The method of claim 1, wherein the Sₓ is reported by UE capability.

4. The method of claim 1, further comprising determining a second Sₓ and a second freeze point, wherein any of the uplink grants that start in a first region of the slot cannot be associated with a DCI that is received after the freeze point, and any of the uplink grants that starts in a second region of the slot cannot be associated with a DCI that is received after the second freeze point.

5. The method of claim 4, wherein a first uplink grant that starts in the first region cannot overlap with a second uplink grant that starts in the second region.

6. The method of claim 1, wherein the processing time is based on a minimum Subcarrier Spacing (SCS) between involved channels.

7. The method of claim 1, wherein the processing time is different for signals with different priorities.

8. The method of claim 1, further comprising receiving, from the UE, a UE capability report, wherein the anchor timing is based on the UE capability report and resources to be processed by the UE within a physical uplink control channel (PUCCH) slot.

9. The method of claim 1, further comprising indicating physical uplink control channel (PUCCH) formats, and wherein a starting symbol and duration of the PUCCH formats do not change.

10. A network node computing apparatus comprising:
a processor; and
a memory storing instructions that, when executed by the processor, configure the apparatus to:
define anchor timing for a user equipment (UE) by:
determine a starting symbol (Sₓ) for the anchor timing, and
determine a processing time for the UE, wherein the anchor timing defines a period reserved for the UE to process uplink grants for a slot;
determine a freeze point that is positioned at least the processing time before Sₓ; and
send, to the UE, the uplink grants prior to the freeze point.

11. The network node computing apparatus of claim 10, wherein the Sₓ is fixed relative to the slot.

12. The network node computing apparatus of claim 10, wherein the Sₓ is reported by UE capability.

13. The network node computing apparatus of claim 10, wherein the instructions further configure the apparatus to determine a second Sₓ and a second freeze point, wherein any of the uplink grants that start in a first region of the slot cannot be associated with a DCI that is received after the freeze point, and any of the uplink grants that starts in a second region of the slot cannot be associated with a DCI that is received after the second freeze point.

14. The network node computing apparatus of claim 13, wherein a first uplink grant that starts in the first region cannot overlap with a second uplink grant that starts in the second region.

15. The network node computing apparatus of claim 10, wherein the processing time is based on a minimum Subcarrier Spacing (SCS) between involved channels.

16. The network node computing apparatus of claim 10, wherein the processing time is different for signals with different priorities.

17. A non-transitory computer-readable storage medium for a network node, the computer-readable storage medium including instructions that when executed by a computer, cause the computer to:
define anchor timing for a user equipment (UE) by:
determine a starting symbol (Sₓ) for the anchor timing, and
determine a processing time for the UE, wherein the anchor timing defines a period reserved for the UE to process uplink grants for a slot;
determine a freeze point that is positioned at least the processing time before Sₓ; and
send, to the UE, the uplink grants prior to the freeze point.

18. The computer-readable storage medium of claim 17, wherein the Sₓ is fixed relative to the slot.

19. The computer-readable storage medium of claim 17, wherein the Sₓ is reported by UE capability.

20. The computer-readable storage medium of claim 17, wherein the instructions further configure the computer to determine a second Sₓ and a second freeze point, wherein any of the uplink grants that start in a first region of the slot cannot be associated with a DCI that is received after the freeze point, and any of the uplink grants that starts in a second region of the slot cannot be associated with a DCI that is received after the second freeze point.
